(19) United States
(12) Patent Application Publication
(10) Pub. No.: US 2015/0153178 A1
(43) Pub. Date: Jun. 4, 2015

(54) CAR NAVIGATION SYSTEM AND METHOD IN WHICH GLOBAL NAVIGATION SATELLITE SYSTEM (GNSS) AND DEAD RECKONING (DR) ARE MERGED

(71) Applicant: HYUNDAI MOBIS CO., LTD., Seoul (KR)

(72) Inventors: Bon Wook Koo, Yongin-si (KR); Sang Sun Lee, Seoul (KR); Joon Seong Gim, Seoul (KR); Dong Keon Lee, Seoul (KR)

(73) Assignee: HYUNDAI MOBIS CO., LTD., Seoul (KR)

(21) Appl. No.: 14/264,824

(22) Filed: Apr. 29, 2014

(30) Foreign Application Priority Data
Nov. 29, 2013 (KR) 10-2013-0147349

(51) Int. Cl. G01C 21/12

(52) U.S. Cl. CPC G01C 21/12

(57) ABSTRACT

Disclosed is a car navigation system and method. The present invention includes a sensor unit including a plurality of sensors, each, configured to measure a state of a vehicle using a predetermined scheme and to obtain sensor data; a vehicle to everything (V2X) unit configured to receive the sensor data from the sensor unit, and including a global navigation satellite system (GNSS) module to thereby receive a satellite signal and to generate GNSS data; and a position estimator configured to receive the sensor data and the GNSS data from the V2X unit, to evaluate an accuracy of each of the sensor data and the GNSS data using a predetermined scheme, and to obtain position coordinates of the vehicle by merging GNSS position coordinates obtained from the GNSS data and dead reckoning (DR) position coordinates obtained from the sensor data based on the evaluation result.

### CROSS-REFERENCE TO RELATED APPLICATIONS

This application claims priority to and the benefit of Korean Patent Application No. 10-2013-0147349 filed in the Korean Intellectual Property Office on Nov. 29, 2013, the entire contents of which are incorporated herein by reference.

### TECHNICAL FIELD

The present invention relates to a car navigation system and method, and more particularly, to a car navigation system and method in which a global navigation satellite system (GNSS) and dead reckoning (DR) are merged.

### BACKGROUND ART

In a navigation system configured to guide a moving object to a destination by providing position information and path information to the moving object such as an airplane, a ship, and a vehicle, it is important to initially determine an accurate position of the moving object.

Currently, most navigation systems are basically using a global navigation satellite system (GNSS) configured to accurately track a position of a target object present on the ground using an artificial satellite network. The GNSS is a name that combines various positioning systems using a satellite, such as the American global positioning system (GPS), the Russian global navigation satellite system (GLONASS), GALILEO of the European Union (EU), and a Beidou navigation satellite system (BDS) of China (compass).

The GNSS determines a position using a satellite and thus, may easily obtain position information without being restricted by time and space. The GNSS basically has an error within a predetermined range at all times and thus, is classified as a relatively stable system compared to other navigation systems. However, due to an offset of the visual field, affect of the atmosphere and the ionosphere, a multipath, and receiver noise, an error may occur in position information. Alternatively, a satellite signal may not be received due to an obstacle and thus, a position may not be determined.

Accordingly, in many cases, a current navigation system is merged with another system and thereby used compared to a case in which only the GNSS is used alone. Dead reckoning (DR) using sensing values of various types of sensors is a system merged with the GNSS and thereby used.

The DR is a general technology utilized for position setting and navigation, and obtains position data and path data of a moving object using an encoder, a geomagnetic sensor, and a sensor such as an electronic compass. The DR has an advantage in that it is possible to provide very accurate navigation information within a short period of time, however, when an error occurs, errors are infinitely accumulated over time. Thus, there is a limit that the DR cannot be used alone for navigation of the moving object. Accordingly, a variety of researches on the navigation system in which the GNSS and the DR are merged are ongoing.

FIG. 1 illustrates an example of a merged navigation system according to the related art.

FIG. 1 relates to a technology about a DR/GPS data merging method disclosed in Korean Registration Patent No. 10-1141984 in which DR data and GPS data is merged through a process of adjusting a weight of DR data of a DR apparatus 11 and a weight of GPS data of a GPS receiver 12 based on a Kalman filter form. Here, the process of adjusting the weight of DR data and the weight of GPS data includes a first process of estimating a position of a moving object based on an initial measurement value of a GPS and a second process of estimating all of the positions subsequent to the estimated position.

The first process between the first process and the second process includes an operation of collecting GPS data, an operation of measuring DR data, an operation of setting a current position of the moving object as GPS-based coordinates based on the GPS data, an operation of merging the GPS data and the DR data, and outputting the merged DR/GPS data. According to the invention of FIG. 1, a position error of the GPS decreases and an accuracy of the GPS increases by applying a Kalman filter-based estimation navigation scheme. Accordingly, the invention of FIG. 1 may be effectively applied to a smart cruise of a ship, which helps prevent a collision between ships.

However, a position accuracy of a GNSS in an open sky environment greatly depends on the self-performance of a GNSS receiver, whereas the position accuracy of the GNSS in a metro area, forest areas, or a tunnel besides the open sky environment decreases. A position accuracy of sensor-based DR within a short period is relatively high, however, position errors are accumulated over time. Accordingly, periodic and static merging with the sensor-based DR at a point (area) at which the position accuracy of the GNSS is not secured accumulates position errors over time and decreases the overall measurement accuracy.

That is, the existing navigation system in which the GNSS and the DR are merged is useful in a state in which the position accuracy measured by the GNSS is secured. However, in an area in which the position accuracy of the GNSS is not secured, the DR may not correct an initial position error of the GNSS. Due to a characteristic of the DR, errors are accumulated and thus, it is difficult to obtain an accurate position.

### SUMMARY OF THE INVENTION

The present invention has been made in an effort to provide a car navigation system that may increase a position estimation accuracy by dynamically applying sensor data based on an accuracy of global navigation satellite system (GNSS) data.

The present invention also has been made in an effort to provide a car navigation method to achieve the object.

An exemplary embodiment of the present invention provides a car navigation system, including: a sensor unit including a plurality of sensors, each, configured to measure a state of a vehicle using a predetermined scheme and to obtain sensor data; a vehicle to everything (V2X) unit configured to receive the sensor data from the sensor unit, and including a GNSS module to thereby receive a satellite signal and to generate GNSS data; and a position estimator configured to receive the sensor data and the GNSS data from the V2X unit, to evaluate an accuracy of each of the sensor data and the GNSS data using a predetermined scheme, and to obtain position coordinates of the vehicle by merging GNSS position coordinates obtained from the GNSS data and dead reckoning (DR) position coordinates obtained from the sensor data based on the evaluation result.

The position estimator may include: a data extractor configured to receive the sensor data and the GNSS data from the V2X unit, to extract, from the sensor data, sensor analysis data including steering angle, wheel pulse, acceleration, and yaw rate data, and to extract the GNSS raw measurement data from the GNSS data; a data-based position estimator configured to receive the GNSS raw measurement data and the sensor analysis data from the data extractor, to estimate the GNSS position coordinates from the GNSS raw measurement data, and to estimate the DR position coordinates from the sensor analysis data; an accuracy calculator configured to determine an accuracy of each of the GNSS raw measurement data and the sensor analysis data; and a final position calculator configured to calculate the position coordinates of the vehicle using the GNSS position coordinates, based on the accuracy of each of the GNSS raw measurement data and the sensor analysis data determined by the accuracy calculator, or to calculate the position coordinates of the vehicle by merging the GNSS position coordinates and the DR position coordinates.

Another exemplary embodiment of the present invention provides a car navigation method of a car navigation system including a sensor unit including a plurality of sensors, each, configured to measure a state of a vehicle using a predetermined scheme and to obtain sensor data, a V2X unit configured to receive the sensor data from the sensor unit, and including a GNSS module to thereby receive a satellite signal and to generate GNSS data, and a position estimator, the method including: by the position estimator, receiving at least one of the sensor data and the GNSS data from the V2X unit; obtaining DR position coordinates from the sensor data; obtaining GNSS position coordinates from the GNSS data; estimating a position of the vehicle based on the DR position coordinates and the GNSS position coordinates; calculating and evaluating an accuracy of each of the sensor data and the GNSS data using a predetermined scheme; and obtaining position coordinates of the vehicle by merging the GNSS position coordinates and the DR position coordinates based on the evaluation result.

The receiving of the at least one may include: determining whether the GNSS data is received; synchronizing the GNSS data and the sensor data by analyzing and matching a time of the GNSS data and a time of the sensor data when the GNSS data is received; and extracting, from the sensor data, sensor analysis data including a steering angle, a wheel pulse, acceleration, and yaw rate data.

The estimating of the position coordinates of the vehicle may include: determining whether the obtained GNSS position coordinates are initial GNSS position coordinates that are initially obtained after driving a GNSS; estimating the position coordinates of the vehicle based on the initial GNSS position coordinates and the DR position coordinates when the obtained GNSS position coordinates are the initial GNSS position coordinates; and estimating the position coordinates of the vehicle based on previously stored final position coordinates and the DR position coordinates when the obtained GNSS position coordinates are not the initial GNSS position coordinates or when the GNSS data is not received.

The obtaining of the position coordinates of the vehicle may include: obtaining the position coordinates of the vehicle by merging and correcting the previously stored final position coordinates and the DR position coordinates using a Kalman filter when the accuracy of the GNSS data is less than a predetermined first reference value as the evaluation result; obtaining the position coordinates of the vehicle by merging and correcting the GNSS position coordinates and the DR position coordinates using the Kalman filter when the accuracy of the GNSS data is greater than or equal to the first reference value and the accuracy of the sensor data is greater than or equal to a predetermined second reference value; and obtaining the position coordinates of the vehicle by correcting the GNSS position coordinates using the Kalman filter when the accuracy of the GNSS data is greater than or equal to the first reference value and the accuracy of the sensor data is less than the second reference value.

According to exemplary embodiments of the present invention, a car navigation system and method may obtain final position coordinates by determining an accuracy of each of GNSS position coordinates and DR position coordinates, and by dynamically merging the DR position coordinates with currently received GNSS position coordinates or previously calculated final position coordinates based on the determination result and thus, may minimally maintain a measurement error and may analyze a component of an error that may occur when measuring a position through a variety of parameters for accurate calculation, and the cause of error occurrence. Parameters may be reset based on a result of analyzing the cause of error occurrence.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example of a merged navigation system according to the related art.

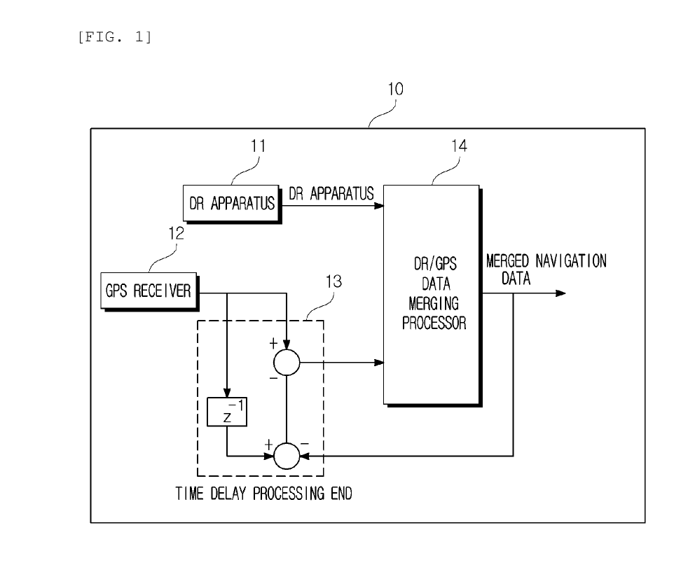

FIG. 2 illustrates a car navigation system according to an exemplary embodiment of the present invention.

FIG. 3 illustrates a detailed configuration of a position estimator of FIG. 2.

FIG. 4 illustrates a car navigation method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

To fully understand the present invention, operational advantages of the present invention, and objects achieved by carrying out the present invention, the accompanying drawings exemplifying exemplary embodiments of the present invention and contents disclosed therein need to be referred to.

Hereinafter, the present invention will be described in detail by describing the exemplary embodiments of the present invention with reference to the accompanying drawings. However, the present invention may be configured in various different forms and is not limited to the exemplary embodiments. A portion irrelevant to a description for clearly describing the present invention is omitted and like reference numerals in the drawings refer to like constituent elements throughout.

Throughout the present specification, when it is described that a predetermined portion “includes/comprises” a predetermined constituent element, it indicates that the predetermined portion may further include another constituent element instead of excluding the other constituent element, unless differently described. The term, such as “˜unit”, “˜er/or”, “module”, and “block”, described in the specification indicates a unit for processing at least one function or operation, which may be embodied using hardware or software, or combination of hardware and software.

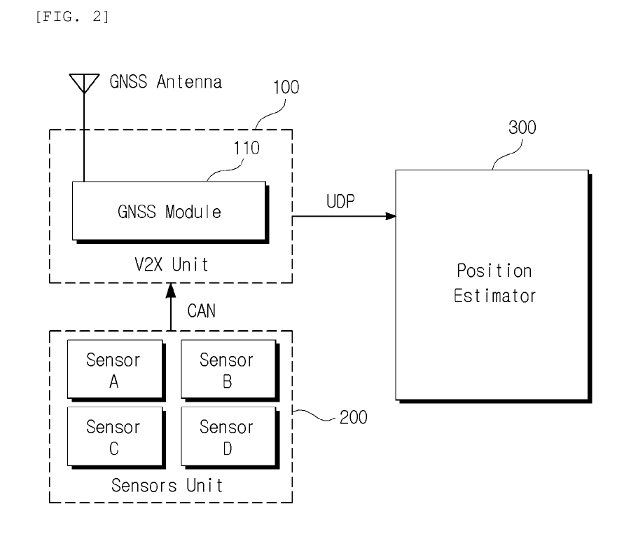

FIG. 2 illustrates a car navigation system according to an exemplary embodiment of the present invention.

Referring to FIG. 2, the car navigation system of the present invention includes a vehicle to everything (V2X) unit 100, a sensor unit 200, and a position estimator 300.

The V2X unit 100 is a terminal that supports automatic control and safe driving of a vehicle, such as automatically recognizing a driving and road environment and providing the recognized driving and road environment to a driver while a vehicle is being driven. The V2X unit 100 generally supports vehicle to vehicle (V2V) communication and vehicle to infrastructure (V2I) communication, thereby enabling a variety of information for vehicle driving to be transmitted and received.

In particular, the V2X unit 100 of the present invention includes a global navigation satellite system (GNSS) module 110 to thereby collect GNSS data. The GNSS module 110 receives a satellite signal through a GNSS antenna from a satellite such as a global positioning system (GPS), a global navigation satellite system (GLONASS), GALILEO, and a Beidou navigation satellite system (BDS), and generates GNSS data. In the present invention, the GNSS data is GNSS raw measurement data. When analyzing the GNSS raw measurement data, it is possible to obtain the number of satellites used for GNSS positioning and pseudo range information. A time at which the GNSS raw measurement data is obtained is included in the GNSS data.

The V2X unit 100 supports a control area network (CAN) for an in-vehicle communication and collects sensor data transmitted from the sensor unit 200. The V2X unit 100 supports Ethernet communication, and transmits, to the position estimator 300, the collected sensor data and the GNSS data obtained from the GNSS module 110.

The sensor unit 200 includes a plurality of sensors, for example, sensors A, B, C, and D. Each of the plurality of sensors measures a state of the vehicle using a predetermined scheme and obtains sensor data, and transmits the obtained sensor data to the V2X unit 100 over the CAN. The plurality of sensors of the sensor unit 200 may be distributed and thereby arranged over the respective portions of the vehicle instead of being densely arranged, and measures a steering angle, a yaw rate, a wheel pulse, an acceleration, and an angular speed of the vehicle based on the respective functions of the plurality of sensors. A time at which each sensor data is acquired is included in sensor data acquired at each sensor.

The position estimator 300 receives GNSS data and sensor data from the V2X unit 100 using Ethernet, and calculates a position of the vehicle based on the received GNSS data and sensor data.

The position estimator 300 initially verifies times included in the GNSS data and the sensor data, and synchronizes the times of the GNSS data and the sensor data. The position estimator 300 may synchronize the times of the GNSS data and the sensor data by analyzing the time included in the sensor data, and by matching, with the GNSS data, sensing data obtained at the same time as a GNSS universal time coordinated (UTC) time included in the GNSS data. The position estimator 300 obtains DR position coordinates by calculating a travel distance and a rotation angle of the vehicle based on the synchronized sensor data. In the present invention, the DR position coordinates indicate position information of the vehicle calculated from the sensor data. The position estimator 300 merges the DR position coordinates with GNSS position coordinates obtained from the GNSS data that is transmitted from the V2X unit 100 in an initial position estimation stage. The position estimator 300 accurately estimates the position coordinates of the vehicle by analyzing an accuracy of each of the GNSS data and the sensor data obtained from the V2X unit 100 and by dynamically merging the DR position coordinates with the GNSS position coordinates based on the analyzed accuracy.

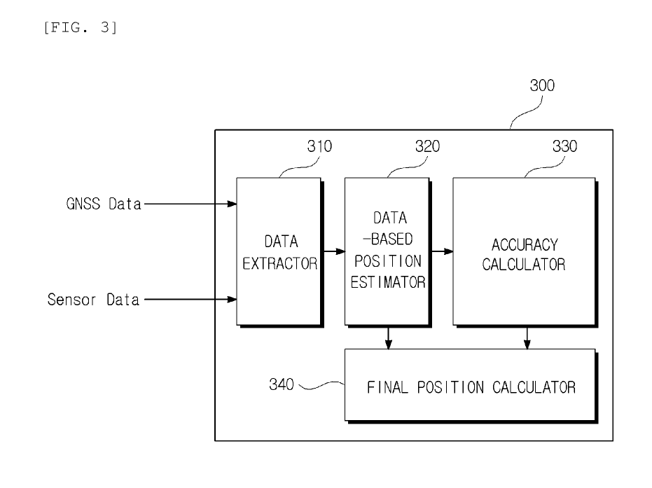

FIG. 3 illustrates a detailed configuration of the position estimator 300 of FIG. 2.

Describing the configuration of the position estimator 300 of FIG. 3 with reference to FIG. 2, the position estimator 300 includes a data extractor 310, a data-based position estimator 320, an accuracy calculator 330, and a final position calculator 340.

The data extractor 310 receives synchronized GNSS data and sensor data that is transmitted from the V2X unit 100. The data extractor 310 initially determines whether the GNSS data is received, and when the GNSS data is received, synchronizes the GNSS data and the sensor data by analyzing and matching a time of the GNSS data and a time of the sensor data. The data extractor 310 extracts steering angle, wheel pulse, acceleration, and yaw rate data from the sensor data, and transmits the extracted steering angle, wheel pulse, acceleration, and yaw rate data to the data-based position estimator 320 as sensor analysis data. When the GNSS data is received, the data extractor 310 transmits GNSS raw measurement data of the GNSS data to the data-based position estimator 320.

The data-based position estimator 320 receives the GNSS raw measurement data and the sensor analysis data from the data extractor 310, and obtains GNSS position coordinates, the number of satellites, and pseudo distance data from the GNSS raw measurement data. The data-based position estimator 320 obtains DR position coordinates by calculating a travel distance and a rotation angle of the vehicle from the sensor data. The data-based position estimator 320 determines whether the obtained GNSS position information is initial GNSS position coordinates that are initially obtained after driving a GNSS, and when the obtained GNSS position information is the initial GNSS position coordinates, estimates the position coordinates of the vehicle based on the initial GNSS position coordinates and the DR position coordinates. However, when the obtained GNSS position information is not the initial GNSS position coordinates or when the GNSS data is not received, the data-based position estimator 320 estimates the position coordinates of the vehicle based on previously stored final position coordinates and DR data. The data-based position estimator 320 transmits the calculated position coordinates, the GNSS data, and the sensor data to the accuracy calculator 330.

The accuracy calculator 330 calculates the accuracy of each of the GNSS data and the sensor data using a predetermined scheme. The accuracy calculator 330 determines whether the calculated accuracy of the GNSS data is greater than or equal to a predetermined first reference value, determines whether the calculated accuracy of the sensor data is greater than or equal to a predetermined second reference value, and transmits the determination result to the final position calculator 340.

The final position calculator 340 stores the previously calculated final position coordinates, receives the position coordinates estimated from the data-based position estimator 320, and receives the determination result as to the accuracy of each of the GNSS data and the sensor data from the accuracy calculator 330. The final position calculator 340 analyzes the determination result received from the accuracy calculator 330. When the accuracy of the GNSS data is less than the first reference value, the accuracy of GNSS position coordinates is low and thus, the GNSS position coordinates estimated by the data-based position estimator 320 delete. The final position calculator 340 obtains final position coordinates by merging and correcting the previously calculated final position coordinates and the DR position coordinates using a Kalman filter. However, when the accuracy of the GNSS data is greater than or equal to the first reference value, the final position calculator 340 analyzes whether the accuracy of the sensor data is determined to be greater than or equal to the second reference value. When the accuracy of the sensor data is determined to be greater than or equal to the second reference value, the final position calculator 340 obtains the final position coordinates by merging and correcting the GNSS position coordinates and the DR position coordinates using the Kalman filter. Conversely, when the accuracy of the sensor data is less than the second reference value, the final position calculator 340 obtains the final position coordinates by deleting the DR position coordinates, by estimating the GNSS position coordinates as position coordinates of the vehicle, and by performing filtering using the Kalman filter. The final position calculator 340 stores the calculated final position coordinates.

Consequently, the car navigation system of the present invention obtains the final position coordinates by determining the accuracy of each of the GNSS position coordinates and the DR position coordinates using the accuracy calculator 330, and by dynamically (selectively) merging the DR position coordinates with the currently received GNSS position coordinates or the previously calculated final position coordinates based on the determination result using the final position calculator 340.

Accordingly, it is possible to minimally maintain a measurement error at all times. It is possible to analyze a component of an error that may occur when measuring a position through a variety of parameters for accurate calculation, and the cause of error occurrence. Parameters may be reset based on a result of analyzing the cause of error occurrence. Accordingly, it is possible to minimize and thereby maintain a position measurement error of a GNSS and DR, and to secure a high accuracy through merging using a Kalman filter based on the measurement result having the minimum error.

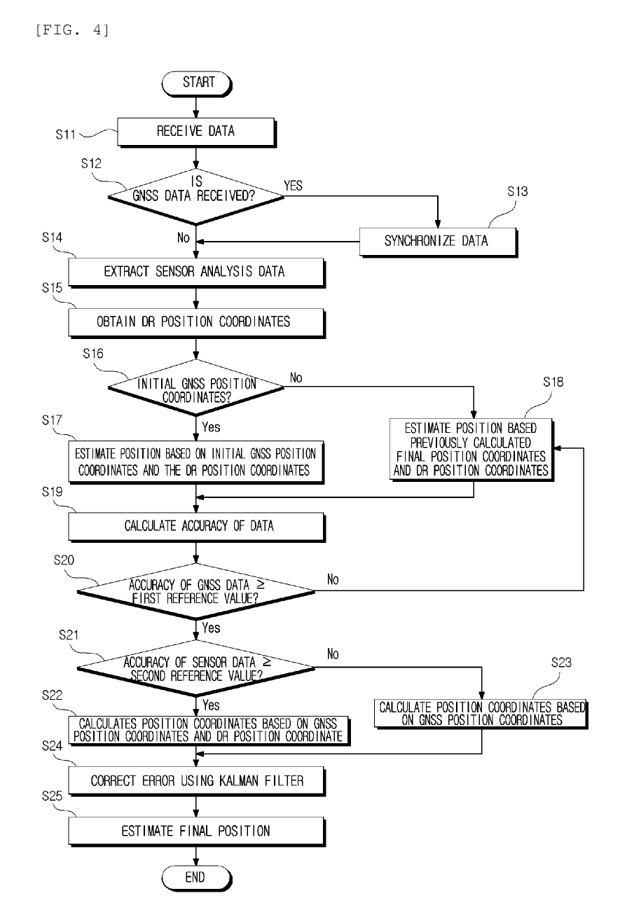

FIG. 4 illustrates a car navigation method according to an exemplary embodiment of the present invention.

Describing the car navigation method of FIG. 4 with reference to FIGS. 2 and 3, the data extractor 310 of the position estimator 300 receives data from the V2X unit 100 (S11). Here, sensor data and GNSS data may be included in the data. The sensor data is data obtained at a sensor provided within a vehicle and thus, may be received at all times. However, the GNSS data is data obtained from a satellite signal and thus, may be irregularly received.

Accordingly, the data extractor 310 determines whether the GNSS data is included in the received data (S12). That is, the data extractor 310 determines whether the GNSS data is received. When the GNSS data is received, the data extractor 310 matches sensor data based on a time of the received GNSS data (S13). The data extractor 310 matches the sensor data obtained at the same time as the time of the GNSS data. Regardless of whether the GNSS data is received, the data extractor 310 extracts, from the sensor data, sensor analysis data including steering angle, wheel pulse, acceleration, and yaw rate data, and transmits the extracted sensor analysis data to the data-based position estimator 320 (S14).

The data-based position estimator 320 obtains DR position coordinates based on the sensor analysis data (S15). When the GNSS data is received from the data extractor 310, the data-based position estimator 320 obtains GNSS position coordinates based on the GNSS data and determines whether the obtained GNSS position coordinates is initial GNSS position coordinates (S16). When the obtained GNSS data is determined as the initial GNSS position coordinates, the data-based position estimator 320 estimates the position coordinates of the vehicle based on the initial GNSS position coordinates and the DR position coordinates (S17). However, when the obtained GNSS data is not the initial GNSS position coordinates or when the GNSS data is not received, the data-based position estimator 320 estimates the position of the vehicle based on previously calculated final position coordinates and the DR position coordinates (S18).

The accuracy calculator 330 receives the GNSS data and the sensor data and calculates an accuracy of each of the GNSS data and the sensor data using a predetermined scheme (S19). The accuracy calculator 330 determines whether the calculated accuracy of the GNSS data is greater than or equal to a predetermined first reference value (S20). When the accuracy of the GNSS data is less than the first reference value, the final position calculator 340 estimates the position of the vehicle based on the previously calculated final position and the DR position coordinates (S18). However, when the accuracy of the GNSS data is greater than or equal to the first reference value, the accuracy calculator 330 determines whether the accuracy of the sensor data is greater than or equal to a predetermined second reference value (S21). When the accuracy of the sensor data is greater than or equal to the second reference value, the final position calculator 340 calculates the position coordinates of the vehicle based on the GNSS position coordinates and the DR position coordinates (S22). However, when the accuracy of the sensor data is less than the second reference value, the final position calculator 340 calculates the position coordinates of the vehicle based on the GNSS position coordinates (S23). The final position calculator 340 corrects an error of position coordinates by filtering the calculated position coordinates of the vehicle using a Kalman filter (S24). Next, the final position calculator 340 estimates the corrected position coordinates as the final position and stores the estimated corrected position coordinates (S25).

The method according to the present invention may be configured as a code readable by computer-readable recording media. The computer-readable recording media may include any type of recording devices storing data readable by a computer system. Examples of the recording media include ROM, RAM, CD-ROM, magnetic tapes, floppy disks, optical data storage devices, and may also include a carrier wave form (for example, transmission over the Internet). The computer-readable recording media may be distributed to a computer system connected to a network and a computer-readable code may be stored and executed therein using a distributed scheme.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A car navigation system, comprising:
a sensor unit comprising a plurality of sensors, each, configured to measure a state of a vehicle using a predetermined scheme and to obtain sensor data;
a vehicle to everything (V2X) unit configured to receive the sensor data from the sensor unit, and comprising a global navigation satellite system (GNSS) module to thereby receive a satellite signal and to generate GNSS data; and
a position estimator configured to receive the sensor data and the GNSS data from the V2X unit, to evaluate an accuracy of each of the sensor data and the GNSS data using a predetermined scheme, and to obtain position coordinates of the vehicle by merging GNSS position coordinates obtained from the GNSS data and dead reckoning (DR) position coordinates obtained from the sensor data based on the evaluation result.

2. The car navigation system of claim 1, wherein the GNSS data comprises GNSS raw measurement data and a time at which the GNSS raw measurement data is obtained.

3. The car navigation system of claim 2, wherein the position estimator comprises:
a data extractor configured to receive the sensor data and the GNSS data from the V2X unit, to extract, from the sensor data, sensor analysis data comprising steering angle, wheel pulse, acceleration, and yaw rate data, and to extract the GNSS raw measurement data from the GNSS data;
a data-based position estimator configured to receive the GNSS raw measurement data and the sensor analysis data from the data extractor, to estimate the GNSS position coordinates from the GNSS raw measurement data, and to estimate the DR position coordinates from the sensor analysis data;
an accuracy calculator configured to determine an accuracy of each of the GNSS raw measurement data and the sensor analysis data; and
a final position calculator configured to calculate the position coordinates of the vehicle using the GNSS position coordinates, based on the accuracy of each of the GNSS raw measurement data and the sensor analysis data determined by the accuracy calculator, or to calculate the position coordinates of the vehicle by merging the GNSS position coordinates and the DR position coordinates.

4. The car navigation system of claim 3, wherein the data extractor determines whether the GNSS data is received from the V2X unit, and when the GNSS data is received, synchronizes the GNSS data and the sensor data by analyzing and matching a time of the GNSS data and a time of the sensor data.

5. The car navigation system of claim 4, wherein the final position calculator stores the position coordinates of the vehicle as final position coordinates.

6. The car navigation system of claim 5, wherein the data-based position estimator determines whether the estimated GNSS position coordinates are initial GNSS position coordinates that are initially obtained after driving a GNSS, when the estimated GNSS position coordinates are the initial GNSS position coordinates, estimates the position coordinates of the vehicle based on the initial GNSS position coordinates and the DR position coordinates, and when the estimated GNSS position coordinates are not the initial GNSS position coordinates, estimates the position coordinates of the vehicle based on previously stored final position coordinates and the DR position coordinates.

7. The car navigation system of claim 6, wherein when the GNSS raw measurement data is not received from the data extractor, the data-based position estimator estimates the position coordinates of the vehicle based on the DR position coordinates corresponding to the received sensor analysis data and the previously stored final position coordinates.

8. The car navigation system of claim 7, wherein the accuracy calculator calculates the accuracy of each of the GNSS data and the sensor data using a predetermined scheme, determines whether the calculated accuracy of the GNSS data is greater than or equal to a predetermined first reference value, determines whether the calculated accuracy of the sensor data is greater than or equal to a predetermined second reference value, and transmits a determination result to the final position calculator.

9. The car navigation system of claim 8, wherein the final position calculator receives the GNSS position coordinates and the DR position coordinates estimated by the data-based position estimator, receives the determination result as to the accuracy of each of the GNSS data and the sensor data determined by the accuracy calculator, and when the accuracy of the GNSS data is less than the first reference value, obtains the position coordinates of the vehicle by merging and correcting the previously stored final position coordinates and the DR position coordinates using a Kalman filter.

10. The car navigation system of claim 9, wherein when the accuracy of the GNSS data is greater than or equal to the first reference value and the accuracy of the sensor data is greater than or equal to the second reference value, the final position calculator obtains the position coordinates of the vehicle by merging and correcting the GNSS position coordinates and the DR position coordinates using the Kalman filter.

11. The car navigation system of claim 10, wherein when the accuracy of the GNSS data is greater than or equal to the first reference value and the accuracy of the sensor data is less than the second reference value, the final position calculator obtains the position coordinates of the vehicle by correcting the GNSS position coordinates using the Kalman filter.

12. A car navigation method of a car navigation system comprising a sensor unit comprising a plurality of sensors, each, configured to measure a state of a vehicle using a predetermined scheme and to obtain sensor data, a V2X unit configured to receive the sensor data from the sensor unit, and comprising a GNSS module to thereby receive a satellite signal and to generate GNSS data, and a position estimator, the method comprising:
by the position estimator,
receiving at least one of the sensor data and the GNSS data from the V2X unit;
obtaining DR position coordinates from the sensor data;
obtaining GNSS position coordinates from the GNSS data;
estimating a position of the vehicle based on the DR position coordinates and the GNSS position coordinates;
calculating and evaluating an accuracy of each of the sensor data and the GNSS data using a predetermined scheme; and
obtaining position coordinates of the vehicle by merging the GNSS position coordinates and the DR position coordinates based on the evaluation result.

13. The method of claim 12, wherein the GNSS data comprises GNSS raw measurement data and a time at which the GNSS raw measurement data is obtained.

14. The method of claim 13, wherein the receiving of the at least one comprises:
determining whether the GNSS data is received;
synchronizing the GNSS data and the sensor data by analyzing and matching a time of the GNSS data and a time of the sensor data when the GNSS data is received; and
extracting, from the sensor data, sensor analysis data comprising steering angle, wheel pulse, acceleration, and yaw rate data.

15. The method of claim 14, wherein the estimating of the position coordinates of the vehicle comprises:
determining whether the obtained GNSS position coordinates are initial GNSS position coordinates that are initially obtained after driving a GNSS;
estimating the position coordinates of the vehicle based on the initial GNSS position coordinates and the DR position coordinates when the obtained GNSS position coordinates are the initial GNSS position coordinates; and
estimating the position coordinates of the vehicle based on previously stored final position coordinates and the DR position coordinates when the obtained GNSS position coordinates are not the initial GNSS position coordinates or when the GNSS data is not received.

16. The method of claim 14, wherein the obtaining of the position coordinates of the vehicle comprises:
obtaining the position coordinates of the vehicle by merging and correcting the previously stored final position coordinates and the DR position coordinates using a Kalman filter when the accuracy of the GNSS data is less than a predetermined first reference value as the evaluation result;
obtaining the position coordinates of the vehicle by merging and correcting the GNSS position coordinates and the DR position coordinates using the Kalman filter when the accuracy of the GNSS data is greater than or equal to the first reference value and the accuracy of the sensor data is greater than or equal to a predetermined second reference value; and
obtaining the position coordinates of the vehicle by correcting the GNSS position coordinates using the Kalman filter when the accuracy of the GNSS data is greater than or equal to the first reference value and the accuracy of the sensor data is less than the second reference value.
